(19) United States
(12) Patent Application Publication
(10) Pub. No.: US 2004/0177383 A1
(43) Pub. Date: Sep. 9, 2004

(54) Embedded graphics metadata

(75) Inventors: James Martinolich, Huntington, NY (US); William D. Hendler, Northport, NY (US)

Correspondence Address: LERNER, DAVID, LITTENBERG,, KRUMHOLZ & MENTLIK, 600 SOUTH AVENUE WEST, WESTFIELD, NJ, 07090, US

(73) Assignee: Chyron Corporation, Melville, NY (US)

(21) Appl. No.: 10/765,022

(22) Filed: Jan. 26, 2004

Related U.S. Application Data
(60) Provisional application No. 60/442,201, filed on Jan. 24, 2003.

(51) Int. Cl. H04N 7/173; H04N 7/00; H04B 1/66; G09G 5/00; H04N 11/00; H04N 7/16; H04N 9/74

(52) U.S. Cl. 725/138; 345/760; 715/501.1; 348/468; 348/461; 715/513; 375/240; 725/109; 725/110; 725/112; 348/563; 348/589

(57) ABSTRACT

Graphics metadata is embedded in an input video signal at a first system, to form a processed video signal which is distributed to a plurality of second systems, typically cable or broadcast systems. Each individual second system can edit the metadata and insert graphics into the video based on the edited metadata so as to form a final signal for broadcast or other distribution to viewers. Thus, each second system can provide a final signal with an appearance consistent with the brand identity of that individual second system. The metadata facilitates storage and retrieval of the video.

### CROSS-REFERENCE TO RELATED APPLICATION

The present application claims the benefit of U.S. Provisional Application No. 60/442,201 filed Jan. 24, 2003, the disclosure of which is hereby incorporated herein.

### BACKGROUND OF THE INVENTION

Video content generally consists of a video signal in which the contents of the signal define a set of pixels for display on a display device. Within the broadcast industry, which is broadly defined to include cable operators, satellite television providers, as well as others, video content is normally processed prior to broadcast. Such processing may include ‘branding’ the content by overlaying the video signal with a broadcaster's logo or other insignia. It may also or otherwise include cropping or sizing the video content, or providing a graphics such as a customized ‘skin’ or shell to frame the displayable video. Moreover, the embedded graphics incorporated in the content commonly add information to the program as, for example, captions added to a sports program which identify a player or give the score of the game, and captions on a newscast identifying the person shown. The process of generating the correct captions typically requires a skilled human operator observing the program and making judgments about what captions to use, or a sophisticated computer system, or some combination of both. It is a relatively expensive process.

There is a new trend in the broadcast industry, in which the same video content is being re-used and re-branded in many different ways by different distribution entities. For example, the same program content may be distributed by two different cable networks, by a conventional broadcast network, and by a DVD packager. Each of these entities may want to maintain a consistent appearance. For example, a cable network may want all captions on its sports broadcasts to appear as yellow type on a blue background, whereas another cable network may want to show all captions as red type on a white background.

Traditionally, a video signal that has been provided with a skin, caption or other graphic cannot have the graphic removed and the original underlying video completely restored, to otherwise return the video to its original appearance. This is because traditional methods of adding graphics necessarily and irreversibly change the underlying video content in the process. Traditional character generators used in video production insert graphics into the video signal as pixel data in analog or video form, so that the pixel data defining graphics occupying a portion of the picture replace the original pixel data for that portion of the picture. Thus, the output of a traditional character generator is simply an analog or digital video signal defining only a part of the original picture, with the remaining parts occupied by the graphics. This video signal does not include the original pixel data defining that portion of the picture occupied by the graphics. Thus, it is impossible to reconstitute the original video without the inserted graphics. While it is possible to replace the graphics with new graphics by passing the signal through another character generator, the new graphics must occupy all of the picture area occupied by the original graphics. Moreover, the step of adding any new graphics requires repetition of all of the same work and cost involved in generating the original graphics.

Therefore, using traditional methods, if graphics are applied at a central production facility before distribution and are not replaced, the graphics will have the same appearance when the program is shown by every distribution entity. If graphics are not applied at a central production facility, or if distribution entities choose to replace the graphics applied at the central production facility, the distribution entities may incur the expense of generating their own graphics. Further improvement to alleviate this problem is desirable.

Reskinning video content for High Definition (“HD”) or standard definition video format, as necessary, is also now performed on a more frequent basis. Broadcasters are increasingly producing live video content for HD and standard definition simultaneously. It is desirable for broadcasters to be able to provide skins and other graphics suitable for either HD or standard definition video format, as required.

Many independent stations have consolidated into station groups that are able to take advantage of the economies of scale. It is thus now even more desirable for local stations to re-skin or re-brand video content provided by their station group, or central video production bank.

Central production banks can feed the same content to many different spoke stations in the network. A similar business model exists with cable networks that now tend to spawn off several sibling networks aimed at different languages, regions or simply to get a bigger share of the television spectrum.

A method that allows various spoke stations to alter the graphics associated with a video signal in a simple and economical way, so as to brand or re-brand the content with their station logos and styles is thus desirable.

It is also desirable that this method use information integral to the video signal such that the information is available with the video signal as it is distributed or archived throughout the video production chain.

It is also desirable that such a method does not require much additional manpower or special training for the video production operator(s), beyond some degree of planning and careful design needed to set the network up.

Most large broadcasters have thousands of hours of video footage in their vaults that they would like to be able to re-use. Indexing the content of such footage is an extremely difficult and costly task. Video search tools are being produced which search for content with a particular person by using advanced image recognition algorithms. Another method is to do character recognition of the on-screen graphics which in many cases describe what is on the screen, especially in news and sports archives. However, these methods are cumbersome.

A method that facilitates searching video archives is thus desirable.

### SUMMARY OF THE INVENTION

One aspect of the invention provides a method of processing an input video signal which includes the step of adding graphics metadata at least partially defining one or more graphics to the video signal so as to provide a processed video signal. As further discussed and defined below, graphics metadata is data which specifies a graphic, but is distinct from the displayable pixel values constituting the video signal. Thus, the step of adding the metadata does not require replacement of any of the original pixel values. Preferably, the processed video signal includes all of the pixel data in said input video signal.

The method most preferably includes the additional step of reading the graphics metadata in into processed video signal and inserting pixel data constituting graphics into the processed video signal so as to form a final signal incorporating one or more visible graphics, the inserted pixel data being based at least in part on the graphics metadata in the processed video signal. The step of adding graphics metadata may be performed in a first or “hub” video production system, whereas the reading and inserting steps may be performed in one or more second or “spoke” systems. The second systems may be remote from the first system, and may be under the control of one or more second entities different from said first entity. For example, the first system may be a central production facility, whereas the individual second systems may be separate cable, broadcast, webcast or disc video distribution facilities.

Particularly preferred methods according to this aspect of the invention include the further step of modifying the graphics metadata read from the processed video signal to provide modified graphics metadata based in part on the graphics metadata in said processed video signal. In these preferred methods, the step of inserting pixel data includes inserting pixel data constituting a graphic as specified by the modified graphics metadata. Because the modifying and inserting steps are performed at the second or spoke systems, each entity operating a second or spoke system may apply its own modifications to the metadata. For example, the modifications can alter the style or form specified by the graphics metadata, so that the final signal distributed by each second system has graphics in a format consistent with the brand identity of that system. Stated another way, each second system can edit the metadata and thus rebrand or reskin the video.

As further discussed below, certain modifications can be performed automatically, without additional labor at the second or spoke system. For example, where the metadata includes content such as captions identifying a person shown on the screen, this content can be preserved during the modification operation. The second or spoke systems need not provide human operators to watch the video and insert the correct caption when a new person appears. In a further example, the first or hub system may provide metadata denoting a position for a logotype, which changes from time to time to keep the logotype at an unobtrusive location in the constantly changing video image. The second or spoke systems may automatically add metadata denoting their appearance of their individual logotypes. Thus, the final video signal provided by each spoke system will incorporate the logotype associated with that system. Here again, the individual spoke systems need not have a human operator observe the video to update the location.

As further discussed below, certain methods according to this aspect of the invention allow for rebranding or reskinning of an HDTV signal for standard definition television, or vice-versa.

Methods according to this aspect of the invention may include storing and retrieving the processed video signal. Because the content (e.g., text captions) incorporated in the metadata is embedded in the processed video signal in the form of alphanumeric data, as distinguished from pixel data constituting a visible image of the caption, the content can be searched and indexed readily, using conventional search software.

A further aspect of the invention a method of treating a processed video signal including pixel data and graphics metadata. The methods according to this aspect of the invention desirably include the steps as disc used above performed by the second or spoke systems.

Yet another aspect of the invention provides a video processing system. The system according to this aspect of the invention desirably includes an input for receiving an input video signal and a character generator subsystem connected to said input. The character generator subsystem is operative to provide graphics metadata defining one or more graphics and to add the graphics metadata to the input video signal so as to provide a processed video signal. The video processing system desirably also includes a processed signal output connected to the character generator subsystem.

Yet another aspect of the invention provides a video delivery system which includes a first video processing system as discussed above. The delivery system most preferably includes one or more second video processing systems and a communications network for conveying the processed signal to the one or more second video processing systems. Most preferably, each second video processing systems is operative to read the graphics metadata embedded in the processed video signal and to insert pixel data constituting graphics into the processed video signal so as to form a final signal incorporating one or more visible graphics. As discussed above in connection with the methods, the inserted pixel data is based at least in part on the graphics metadata in the processed video signal. Most preferably, second video processing system is operative to modify the graphics metadata read from the processed video signal to provide modified graphics metadata based in part on the graphics metadata in the processed video signal, and to insert pixel data as specified by the modified graphics metadata.

### BRIEF DESCRIPTION OF THE DRAWINGS

FIG. 1 is a schematic diagram of a video broadcast network in accordance with an embodiment of the present invention;

FIG. 2 is a functional block depiction of a first video processing system incorporated in the system of FIG. 1;

FIG. 3 is a functional diagram of a second video processing system incorporated in the system of FIG. 1;

FIG. 4 is a functional block diagram depicting certain components of the first video processing system of FIG. 2; and

FIG. 5 is a functional block diagram depicting certain components of the second video processing system of FIG. 3.

### DETAILED DESCRIPTION

“CG graphics” as used herein means computer-generated graphics. The graphics metadata described herein is generally CG graphics-based. It is useful to speak of three CG graphic components when describing graphics metadata. These are the style, the format and the content. Graphics metadata usually includes one or more of these components.

“Style” defines the artistic elements of graphics metadata, such as its color scheme, font treatments, graphics, animating elements, logos, etc. For example, “morning news”, “6 O'Clock News” and “11 PM News” could all have different styles for re-use of the same general textual data, with the styles expressed as graphics metadata. ESPN™ coverage of a tennis match will have a different look or style than the same coverage on ABC™.

“Format” refers to the types of information being presented. A simple format, for example, is the “two-line lower third” used to name the person on the screen. A two-line lower third has the person's name on the top line, and some description on the lower line (i.e., “Joe Smith”, “Eyewitness to Crash”). The format name is important when the content is re-skinned, as the ‘content’ will often need to have the same ‘format’ in a different ‘style.’

“Content” is the actual data used to populate the fields in the graphics. In the case of the two-line lower third, the data might be {name=Joe Smith} and {description=Eyewitness to Crash}.

As used herein, the expression “pixel data” refers to data directly specifying the appearance of the elements of a video display, regardless of whether the data is in digital or analog form or in compressed or uncompressed form. Most typically, the pixel data is provided in digital form, as luminance and chrominance values or RGB values for numerous individual pixels, or in compressed representations of such digital data. Pixel data may also be provided as an analog data stream as, for example, an analog composite video signal such as an NTSC signal.

“Metadata” is generally data that describes other data. As used herein, “graphics metadata” relates to descriptions of the CG graphics to be embedded into the video signal. These CG graphics may include any or all of the elements described above, e.g., style, format and content, as well as any other data of a descriptive or useful nature. The graphics metadata is thus distinguishable from the pixel data, which includes only information describing the pixels for display of a video image. For example, where a video image has been branded by applying a logotype, the video data includes data respecting pixel values (e.g., luminance and chrominance) for each pixel of the display screen, including those pixels forming part of the display screen forming the logotype. By contrast, metadata does not directly define pixel values for particular pixels of the display screen, but instead includes data that can be used to derive pixel values for the display screen.

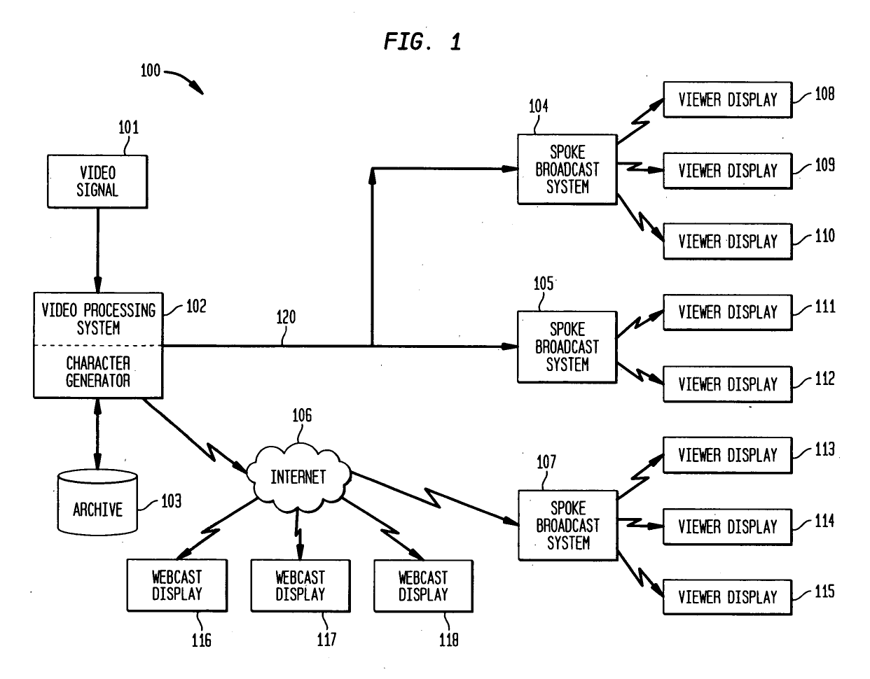

FIG. 1 depicts an exemplary video delivery system 100 in accordance with one embodiment of the present invention. System 100 includes a first video processing system 102 at a first location under the control of a first entity, also referred to as a “hub” entity as, for example, a central video processing operation. As further explained below, the first video processing system 102 is operative to accept an input video signal 101 and to add graphics metadata at least partially specifying one or more graphic elements to that video signal so as to provide a processed video signal incorporating the graphics metadata along with the pixel data of the input video signal. An archival storage system 103 is also connected to the first video processing system 102.

The system 100 further includes several second video processing systems 104, 105 and 107, also referred to as “spoke broadcast systems.” The second video processing systems or spoke broadcast systems may be located remote from the first video processing system and may be under the control of entities other than the hub entity. For example, the various spoke broadcast systems may be operated by several different cable television networks, terrestrial broadcast stations or satellite broadcast stations. A conventional dedicated communications network 120 connects the first or hub video processing system 102 with second or spoke systems 104 and 105 so that the processed video signal from system 102 may be routed to the second or spoke systems. System 102 is connected to second or spoke system 107 through a further communications network incorporating the internet 106, for transmission of the processed video signal to system 107. Each of the second or spoke broadcast systems 104, 105 and 106 is connected to viewer displays 108 through 115. Typically, the viewer displays are conventional standard-definition or high-definition television receivers as, for example, television receivers in the homes of cable subscribers or terrestrial or satellite broadcast viewer. As also explained below, each second or spoke broadcast system 104, 105, 107 is arranged to generate a final video signal in a form intelligible to the viewer displays and to supply that final video signal to the viewer displays. The final video signal may incorporate graphics based at least in part on the graphics metadata in the processed signal, along with pixel data from the processed signal.

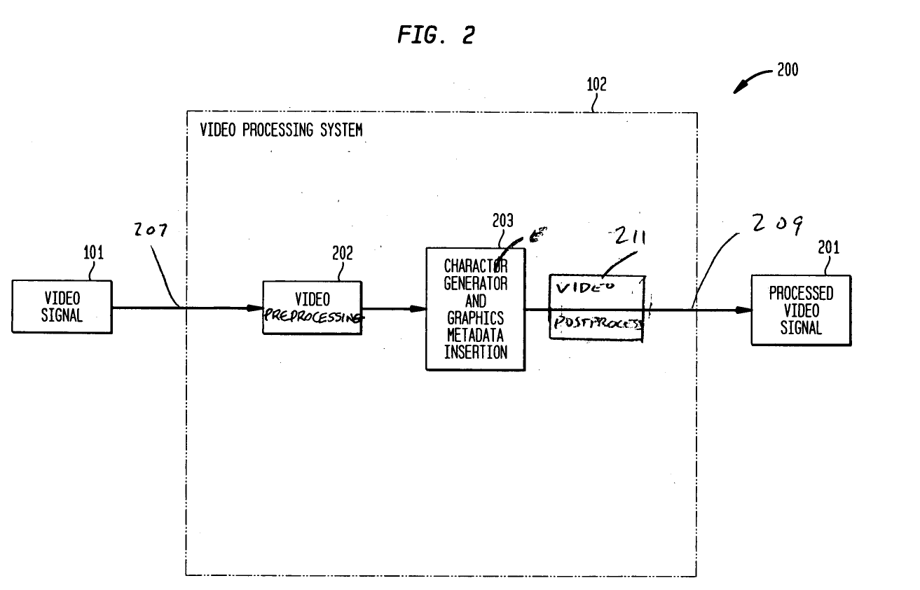

As shown in FIG. 2, the first video processing system 102 includes an input for receipt of the input video signal 101, an output for conveying the processed video signal 201, and a character generator and graphics metadata insertion subsystem 203 connected between the input and output. The first video processing system optionally includes a video preprocessing subsystem 202 and a post-processing subsystem 211. The preprocessing subsystem may include conventional components for altering the signal format of the input video signal into a signal format compatible with subsystem 203 as, for example compression and/or decompression processors, analog-to-digital and/or digital-to-analog converters or both. Merely by way of example, where the input video signal is provided as an analog video stream, the video preprocessing subsystem may include conventional elements for converting the input video stream to a serial data stream. The preprocessing subsystem 202 may also include any other apparatus for modifying the video in any desired manner as, for example, changing the resolution, aspect ratio, or frame rate of the video. The post-processing subsystem 211 may include signal format conversion devices arranged to convert the signal into one or more desired signal formats for transmission. For example, where the signal as processed by the character generator and graphics metadata insertion subsystem 203 is an uncompressed digital or analog video signal, the video postprocessor 211 may include compression systems as, for example, an MPEG-2 compression processor.

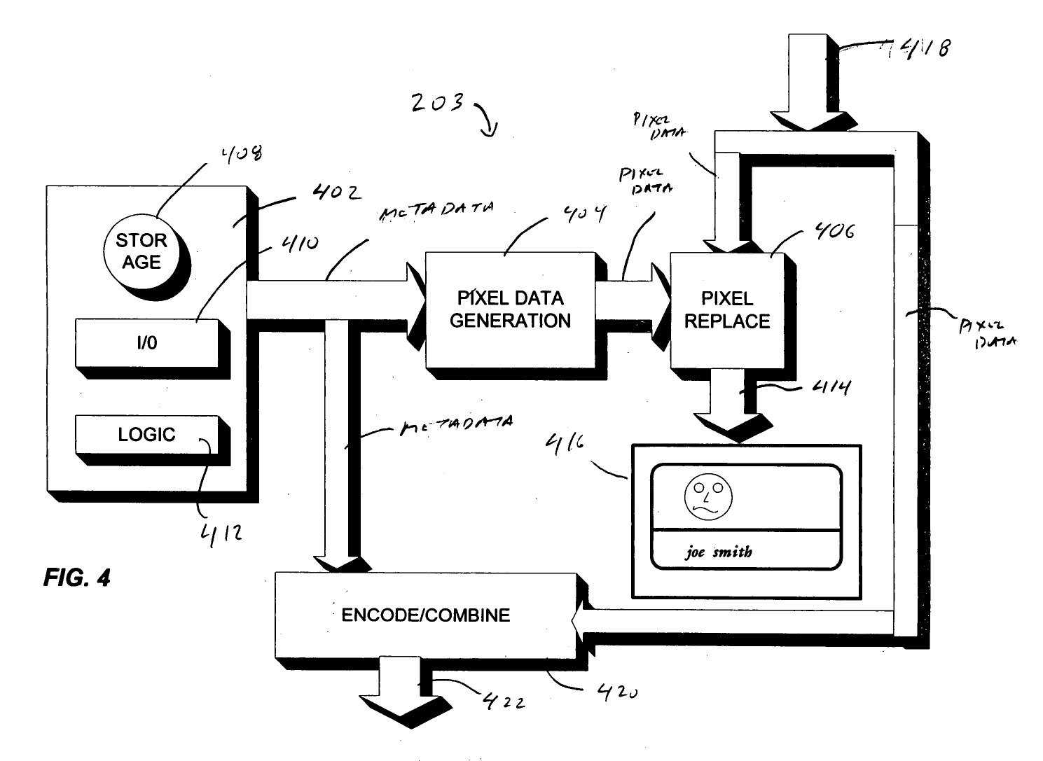

The functional elements of the character generator and graphics metadata subsystem 203 are depicted in FIG. 4. This subsystem incorporates the functional elements of a conventional character generator as, for example, a character generator of the type sold under the trademark DUET by the Chyron Corporation of Melville, N.Y., the assignee of the present application. Functionally, the character generator incorporates a graphic specification system 402, a pixel data generation section 404 and a pixel replacement system 406. The graphic specification system 402 includes a storage unit 408 such as one or more disc drives, input devices 410 such as a keyboard, mouse or other conventional computer input devices, and a programmable logic element 412. In the drawings and in the discussion herein, various elements are shown as functional blocks. Such functional block depiction should not be taken as implying a requirement for separate hardware elements. For example, the pixel data generation system 404 of the character generator may use some or all of the hardware elements constituting the graphic specification system.

The graphic specification system is arranged in known manner to provide metadata specifying graphics to be incorporated in a video signal, in response to commands entered by a human operator and/or in response to stored data or data supplied by another computer system (not shown). The Duet system uses the aforementioned elements of style, form and content to specify the graphic. For example, the data supplied by specification system 402 may be in XML format, with separate entries representing style, form and content, each entry being accompanied by an XML header identifying it. The various elements need not be represented by separate entries. For example, style and form may be combined in a single entry identifying a “template”, which denotes both a predetermined style and a predetermined form.

The pixel data generation system 404 is operative to interpret the metadata and generate pixel data which will provide a visible representation of the graphic specified in the metadata.

The pixel replacement system 406 is arranged to accept incoming pixel data and replace or modify the pixel data in accordance with the pixel data supplied by system 404 so as to form a signal referred to herein as a “burned in” signal 414, with at least some pixel values different from those of the incoming video signal. When displayed, this signal includes the graphic, but does not include all of the original pixel data of the incoming signal. The burned in signal represents the conventional output of the character generator.

The character generator and graphics metadata insertion subsystem 203 also includes a conventional display system 416 such as a monitor capable of displaying the burned-in signal so that the operator can see the graphic.

The character generator and graphics metadata insertion subsystem also includes an input 418 for receiving the input video signal, an encoding and combining circuit 420 and an output 422. The input 418 is connected to the input 207 (FIG. 2) of the video processing system, either directly or through the video preprocessing subsystem 202 (FIG. 2) for receipt of an input video signal. The input 418 is connected to supply the pixel replacement system 406 of the character generator with the incoming video signal. Input 418 is also connected to the encoding and combining circuit 420, so that all of the original pixel data in the input video signal will be conveyed to the encoding and combining circuit without passing through the pixel replacement system 406. The encoding and combining circuit is also connected to the graphic specification system 402 of the character generator, so that the encoding and combining circuit receives the metadata specifying the graphic.

The encoding and combining circuit is arranged to combine the pixel data of the incoming signal with the metadata from specification system 402 so as to form a processed signal at output 422 which includes all of the original pixel data as well as the metadata defining one or more graphics. The processed signal is conveyed to the output 207 (FIG. 2) of the first video processing system, with or without further processing in the post-processing subsystem 211, so as to provide the processed signal 201.

The encoding and combining circuit optionally may be arranged to reformat or translate the metadata into a standard data format as defined, for example, by the MPEG-7 specification or the SMPTE KLV specification. Alternatively, the graphics specification system 402 of the character generator may be arranged to provide the metadata in such as standard format.

The encoding and combining circuit 420 is arranged to embed the metadata in the processed signal in accordance with conventional ways of adding ancillary data to a video signal in a way that synchronizes the data to the video signal. The exact way in which this is done will depend upon the signal format of the video signal. Ancillary data containers exist in all standardized video formats. For example, where the video signal as presented to the encoding and combining circuit 420 is analog composite video such as an NTSC video stream, the metadata can be embedded into line 21 of the vertical blanking interval (“VBI”) along with “close caption” data, and can also be embedded into unused vertical interval lines using the teletext standards.

“Serial digital video” is quickly replacing analog composite video in broadcast facilities. The line 21 close caption and teletext methods can be used to embed metadata in a serial video stream but are inefficient. Serial digital video has ancillary data packets reserved in the unused horizontal and vertical intervals that can be used to carry metadata.

MPEG compressed video streams are used in satellite and digital cable broadcast and in ATSC terrestrial broadcasting, mandated by the FCC as replacing analog broadcasting. There are ancillary data streams available to the user in the composite MPEG stream in order to carry the graphics metadata.

File based storage is the process by which video is treated and stored simply as data. More and more video storage is being done in a file based storage system. In a file-based system, the encoding and combining circuit is arranged to provide the pixel data in a conventional file format. Many of the file formats allow for extra data, so that the metadata may be included in the same file as the pixel data. It is also possible to include the metadata as a separate file associated with the file containing the pixel data by association data which may be incorporated in the file structure itself (e.g., by corresponding file names) or stored in an external management database.

In the foregoing description, the encoding and combining circuit 420 (FIG. 4) has been described separately from the post-processing subsystem 211 (FIG. 2). However, these elements may be combined with one another. For example, where the post-processing circuit includes MPEG-2 or other compression circuitry, the encoding and combining circuit may be arranged to combine the metadata with the compressed pixel data as an ancillary data stream as discussed above. Alternatively, where the input signal supplied at input 418 (FIG. 4) is in the form of MPEG-2 or other compressed video format, the input signal may be supplied to the encoding and combining circuit 420 without decompressing it, and the encoding and combining circuit may be arranged to simply add an ancillary data stream containing the metadata. In this arrangement, a decompression processor may be provided between input 418 and the pixel replacement system 406 of the character generator.

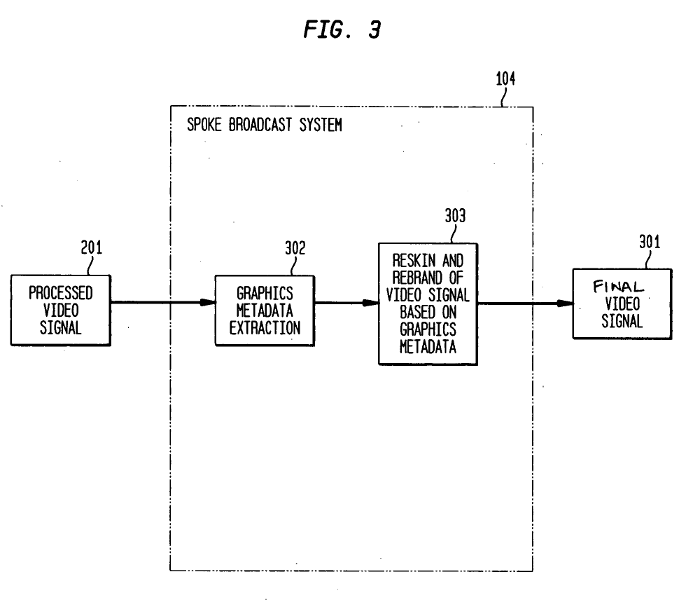

The functions performed by a typical second or spoke system 104 are shown in FIG. 3. The processed video signal 201, including graphics metadata, is communicated to the spoke broadcast system through communications network 120 (FIG. 1). The graphics metadata embedded in the processed video signal 201 is extracted (block 302) and a final or “reprocessed” video signal 301 is derived. As selected by the entity controlling the second or spoke system 104, the final video signal 301 may include pixel data defining graphics exactly as specified by the metadata, or some modified version of such graphics, or may not include any of these graphics. The process of deriving the final video signal is indicated by block 303, and can also be referred to as reskinning and rebranding the video signal.

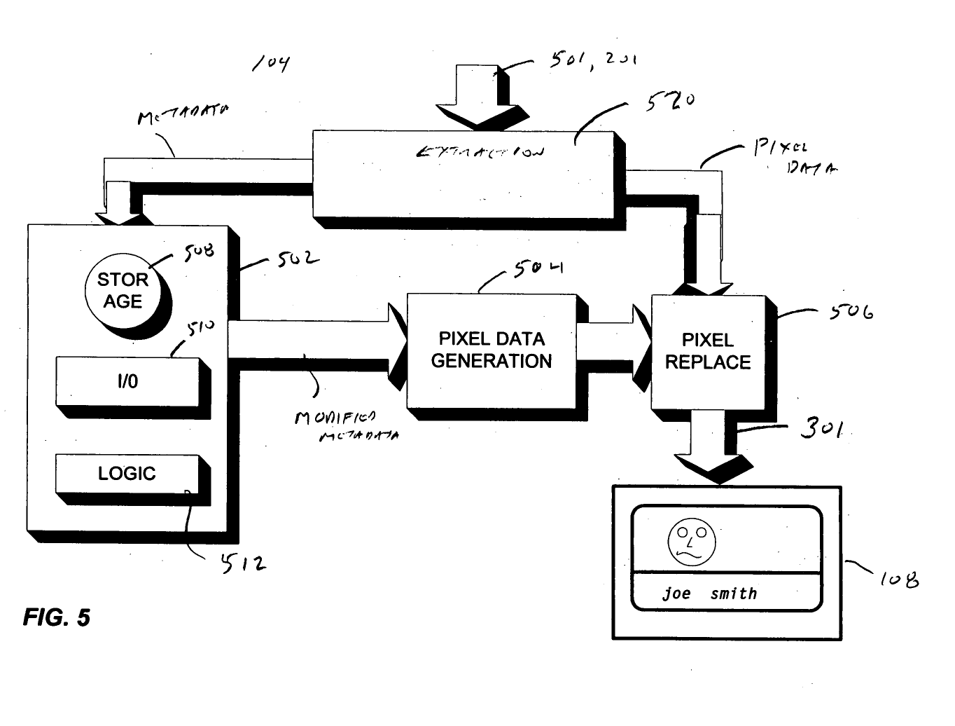

The elements of the second or spoke system 104 which perform these functions are depicted in functional block diagram form in FIG. 5. System 104 includes an input 501 for the processed signal 201, and also includes a character generator having a graphics specification system 502, a pixel data generation system 504 and a pixel replacement system 506. These elements may be substantially identical to the corresponding elements 402, 404 and 406 of the character generator discussed above in connection with FIG. 4, except as otherwise noted below. System 104 further includes a metadata extraction circuit 520 which is arranged to recover the metadata from the processed signal. The extraction process used by the metadata extraction circuit 520 are the inverse of the operations performed by the encoding and combining circuit 420 (FIG. 4). Conventional circuitry and operations used to recover ancillary data from a video signal may be employed. Where the encoding and combining circuit performs a translation of the metadata as discussed above, the extraction circuit desirably performs a reverse translation. The extraction circuit 520 supplies the metadata to the graphics specification system 502 of the character generator, and supplies the pixel data to the pixel replacement system 506 of the character generator.

The graphic specification system 502 forms modified metadata which may be based in whole or in part on the metadata supplied by the extraction circuit 520, and supplies this modified metadata to the pixel data generation unit 504. The pixel generation unit in turn generates pixel data based on the modified metadata, and supplies the pixel data to the pixel replacement system 506. The pixel replacement circuit in turn replaces or modifies pixel data from the processed video signal to provide the final video signal 301, with pixel data including the graphics specified by the modified metadata. This final video signal is conveyed to the viewer displays 108, 109, 110 (FIG. 1) associated with system 104.

The relationship between the modified metadata supplied by the graphics specification system 502 and the metadata read from the processed signal by extraction circuit 520 is controlled by the logic unit 512 in response to commands entered through the input devices 510 and/or commands stored in the storage unit 508. In one extreme case, the logic unit simply passes the metadata supplied by the extraction circuit 520 without changing it, so that the modified metadata is identical to the metadata conveyed in the processed signal 201. In this case, the final signal 301 will be identical to the “burned in” signal 414 (FIG. 4) and the video as displayed on a viewer display will have the same appearance as the video seen on the monitor 416 of the hub or first system. In another extreme case, the logic unit suppresses all of the metadata supplied by the extraction circuit 520. In this case, the final signal 301 will include no pixel data representing graphics, and instead will include all of the original pixel data included in the input video signal 101 (FIG. 1). The area of the picture covered by the graphics as seen on monitor 416 (FIG. 4) will be restored.

In another case, the logic unit 512 causes the graphics specification system 502 to replace certain elements of the metadata supplied by the extraction system so that the modified metadata includes some elements of the extracted metadata and some elements added by system 502 of the second or spoke system 104. For example, where the metadata extracted from the processed signal includes data denoting style, form and content as discussed above, system 502 may replace the style, the form, or both while retaining the content. Where elements of style and form are represented as templates, system 502 may be programmed to automatically replace a particular template in the extracted metadata with a different template retrieved from storage unit 508. This causes the content to be displayed with a different appearance. In the case depicted in FIG. 5, the style of the lettering denoted by the metadata has been changed by system 502, but the content has not been changed. Thus, the video as displayed by viewer display 108 (FIG. 5) has the legend “joe smith” displayed in a different typeface than the video as it appears on monitor 416 (FIG. 4).

Each of the other second or spoke systems 105 and 107 may be substantially identical to system 104. All of these systems may use the metadata supplied by the first or hub system 104. Thus, the entities operating the second or spoke systems need not perform the expensive task of selecting appropriate content for the graphics to be displayed at different times during the program. However, because the modifications to the metadata, and hence the presence or absence of the graphics, and their visual appearance, are controlled by the commands entered into each of the individual second or spoke systems, the final signals provided by the different second or spoke systems may provide different visual impressions. Stated another way, the entity operating each second or spoke system can configure the video in such a way as to maintain its own distinct brand or visual signature.

The metadata incorporated in the processed signal by the first or hub system 102 need not include all of the elements required to completely specify a graphic. In one example, the metadata incorporated in the processed signal may include a positional reference for insertion of a local broadcast station logo, without information defining the appearance of the logo. The human operator or a computer system at the hub system 102 observes the program content as defined by the pixel information and changes the positional reference as needed so that the screen location specified by the positional reference corresponds to a relatively unimportant portion of the picture. The second or spoke systems 104, 105 and 107 respond to this positional reference by automatically adding metadata elements denoting the individual logotypes associated with these systems, to provide modified metadata. Thus, the logotype of each individual second or spoke system can be displayed. This avoids the need for a human operator at each second or spoke system to observe the video image and move the logotype.

Local broadcast stations, such as might be represented herein by spoke broadcast systems 104, 105, 107, often operate in diverse languages from one another. In a further variant, the second or spoke systems can perform automatic translation of text content denoted by the metadata. In yet another variant, the metadata as supplied by the hub system 102 may include a plurality of content denotations in different languages, and the hub or second systems may be programmed to pick one of these corresponding to the local language.

The processed signal may be stored to and retrieved from an archival database maintained on storage unit 103 (FIG. 1) by the video processing system 102. By storing the processed signal, the entire pixel content of the input video signal 101 is stored along with the graphics metadata. The metadata can be searched and indexed using conventional software for searching and indexing text. In particular, the text content denoted by the metadata is readily searchable. Because the metadata is embedded in the processed signal, a search which identifies particular metadata as, for example, a search for content including a particular name, inherently identifies a video program (pixel data stream) relevant to that name. Moreover, because the metadata is embedded in the processed signal, the embedded graphics metadata stays with the video signal as it is distributed or archived throughout the video production chain. For example, any of the spoke or second systems 104, 105 and 107 which receive the processed signal can maintain a similar database.

In a further variant, the burned-in signal 414 (FIG. 4) provided by the pixel replacement process of the character generator at the first or hub system can be distributed and shown as such, in addition to distribution of the processed signal. For example, as shown in FIG. 1, the first or hub system may webcast the burned-in signal over the internet to webcast displays 116, 117 and 118. In yet another variant, the pixel data in the burned-in signal can be combined with the metadata in the same way as discussed above, so as to provide an alternate processed signal, which also may be distributed and viewed. Because such an alternate processed signal does not include all of the pixel data in the input signal, it is more difficult to modify the graphics at a second or hub system. However, such an alternate processed signal can be archived and indexed in exactly the same way as the processed signal discussed above.

The system and method discussed herein may include numerous additional or supplementary steps and/or components not depicted or described herein. For example, although only three second or spoke broadcast systems 104, 105, 107 are depicted in FIG. 1, any number of such spoke broadcast ay actually be employed. Also, the second or spoke systems may include elements similar to the preprocessing and post-processing elements 202 and 211 (FIG. 2) discussed above with reference to the first or hub system 102, which may alter the video in any desired way. For example, the processed signal distributed by the hub system 102 may be a high definition (HDTV) signal. One or more of the spoke systems may downconvert such a high definition signal to a standard definition (e.g., NTSC or the corresponding CCIR 601 digital representation) signal using conventional techniques. The character generator at such spoke system can use the graphics metadata extracted from the processed signal to create graphics in a form suitable for the standard definition signal. The reverse process, with a standard-definition processed signal upconverted to HDTV at the spoke systems, can also be used. Thus, broadcasters or others in the video distribution chain can reskin video content for either HD or standard definition video format, as needed.

As discussed above, the preferred methods described herein save manpower at the spoke systems. Moreover, these methods can be realized without significant additional manpower or special training at hub systems. The actions required by the operator at the hub system are substantially identical to the actions required to use a conventional character generator in production of a conventional program with burned-in graphics.

1. A method of processing an input video signal, including the step of adding of graphics metadata at least partially defining one or more graphics to the video signal so as to provide a processed video signal.

2. A method as claimed in claim 1 wherein said input video signal includes pixel data and said processed video signal includes all of the pixel data in said input video signal.

3. The method according to claim 1, wherein the video signal is an analog composite video signal and the graphics metadata is inserted into one or more vertical blanking intervals of the video signal.

4. The method according to claim 1, wherein the video signal is a serial digital video signal and the graphics metadata is in accordance with MPEG-7 standards.

5. The method according to claim 4, wherein the video signal is an MPEG compressed stream.

6. The method according to claim 1, wherein said adding step is performed using a character generator subsystem operated by a human operator and the operator at least partially controls the graphics metadata added to the video signal.

7. The method according to claim 6, wherein the character generator subsystem is operated by a combination of a human operator and an automated computer system.

8. The method according to claim 1, wherein said adding step is performed using a character generator subsystem operated under the control of an automated computer system.

9. The method according to claim 1, further comprising reading the graphics metadata in said processed video signal and inserting pixel data constituting graphics into the processed video signal so as to form a final signal incorporating one or more visible graphics, said inserted pixel data being based at least in part on the graphics metadata in said processed video signal.

10. The method as claimed in claim 9, wherein said step of adding graphics metadata is performed in a first video production system under the control of a first entity and said reading and inserting steps are performed in a second video system under the control of a second entity different from said first entity, the method further comprising the step of transmitting the processed video signal from said first video production system to said second video production system.

11. The method as claimed in claim 9, wherein said step of adding graphics metadata is performed in a first video production system at a first location and said reading and inserting steps are performed in a second video system at a second location remote from said first location, the method further comprising the step of transmitting the processed video signal from said first video production system to said second video production system.

12. The method as claimed in claim 9, further comprising the step of storing the processed video signal and retrieving the processed video signal from storage, said reading and inserting steps being performed on the processed video signal after said retrieving step.

13. The method as claimed in claim 9 or claim 10 or claim 11 or claim 12, further comprising the step of modifying the graphics metadata read from the processed video signal to provide modified graphics metadata based in part on the graphics metadata in said processed video signal, said step of inserting pixel data including inserting pixel data constituting a graphic as specified by the modified graphics metadata.

14. The method as claimed in claim 13, wherein said modifying step is performed automatically.

15. The method as claimed in claim 13, wherein said modifying step includes replacing at least some of said graphics metadata in said processed video signal with modification data.

16. The method as claimed in claim 13, wherein said modifying step includes adding modification data to the graphics metadata in said processed video signal.

17. The method as claimed in claim 16, wherein said graphics metadata in said processed video signal include data specifying a location for a logotype and said modifying step includes combining said location data with modification data specifying a particular logotype.

18. The method according to claim 9, wherein the inserted graphics includes computer generated graphics.

19. The method according to claim 9, wherein the inserted graphics include one or more style components.

20. The method according to claim 9, wherein the inserted graphics include one or more format components.

21. The method according to claim 9, wherein the inserted graphics include one or more content components.

22. A method of treating a processed video signal including pixel data and graphics metadata comprising reading the graphics metadata in said processed video signal and inserting pixel data constituting graphics into the processed video signal so as to form a final signal incorporating one or more visible graphics, said inserted pixel data being based at least in part on the graphics metadata in said processed video signal.

23. The method as claimed in claim 22 further comprising the step of modifying the graphics metadata read from the processed video signal to provide modified graphics metadata based in part on the graphics metadata in said processed video signal, said step of inserting pixel data including inserting pixel data as specified by the modified graphics metadata.

24. A method as claimed in claim 23, wherein said modifying step includes replacing at least some of said graphics metadata in said processed video signal with modification data.

25. The method as claimed in claim 23, wherein said modifying step includes adding modification data to the graphics metadata in said processed video signal.

26. A video processing system having:
(a) an input for receiving an input video signal;
(b) a character generator subsystem connected to said input, said character generator subsystem being operative to provide graphics metadata defining one or more graphics and add said graphics metadata to the input video signal so as to provide a processed video signal; and
(c) a processed signal output connected to said character generator subsystem.

27. The video processing system according to claim 26, wherein said input is operative to accept said input signal as a serial digital video signal and said character generator subsystem is operative to embed the graphics metadata in the serial digital video signal.

28. The video processing system according to claim 26, wherein said input is operative to accept said input signal in the form of an analog video signal.

29. The video processing system according to claim 28, wherein said character generator subsystem is operative to insert said graphics metadata into one or more video blanking intervals of the analog video signal.

30. The video processing system according to claim 26, wherein the said input is operative to accept said input video signal in the form of an MPEG compressed stream.

31. A video delivery system comprising a first video processing system according to claim 26, one or more second video processing systems and a communications network connected between said processed signal output and said one or more second video processing systems for conveying said processed signal output to said one or more second video processing systems.

32. The video delivery system according to claim 31, wherein at least one of said one or more second video processing systems is operative to read the graphics metadata embedded in the processed video signal and to insert pixel data constituting graphics into the processed video signal so as to form a final signal incorporating one or more visible graphics, said inserted pixel data being based at least in part on the graphics metadata in said processed video signal.

33. A video system according to claim 32, wherein said at least one of said one or more second video processing systems is operative to modify the graphics metadata read from the processed video signal to provide modified graphics metadata based in part on the graphics metadata in said processed video signal, and to inserting pixel data as specified by the modified graphics metadata.

34. A video processing system as claimed in claim 26, further comprising an archival storage element in communication with said output for recording the said processed video signal.
